(19) United States
(12) Patent Application Publication
(10) Pub. No.: US 2026/0057033 A1
(43) Pub. Date: Feb. 26, 2026

(54) NEURAL NETWORK DEVICE AND METHOD FOR RAPIDLY FINDING SOLUTION TO QUADRATIC ASSIGNMENT PROBLEM

(71) Applicant: ELECTRONICS AND TELECOMMUNICATIONS RESEARCH INSTITUTE, Daejeon (KR)

(72) Inventors: Hyun Joong KANG, Daejeon (KR); Yeon Hee LEE, Daejeon (KR); Young Min KIM, Daejeon (KR); Tae Hwan KIM, Daejeon (KR); Hyun Jae KIM, Daejeon (KR); Tae Wan YOU, Daejeon (KR); Ho Sung LEE, Daejeon (KR); Wan Seon LIM, Daejeon (KR); Jong Arm JUN, Daejeon (KR); Seong Ik CHO, Daejeon (KR)

(21) Appl. No.: 19/308,411

(22) Filed: Aug. 25, 2025

(30) Foreign Application Priority Data
Aug. 23, 2024 (KR) 10-2024-0113882

(51) Int. Cl. G06F 17/11; G06Q 10/04

(52) U.S. Cl. CPC G06F 17/11; G06Q 10/04

(57) ABSTRACT

Provided are a neural network device and method for rapidly finding a solution to a quadratic assignment problem (QAP). The neural network device includes a memory and a processor configured to generate logits for locations and facilities on the basis of a QAP instance stored in the memory, generate assignment matrices for the locations and the facilities through deep learning-based parallel processing of the generated logits, and find a solution to the QAP by calculating costs on the basis of the generated assignment matrices.

### CROSS-REFERENCE TO RELATED APPLICATION

This application claims priority to and the benefit of Korean Patent Application No. 10-2024-0113882, filed on Aug. 23, 2024, the disclosure of which is incorporated herein by reference in its entirety.

### BACKGROUND

### 1. Field of the Invention

The present invention relates to a neural network device and method for rapidly finding a solution to a quadratic assignment problem (QAP).

### 2. Description of Related Art

Quadratic assignment problems (QAPs) frequently occur in various fields.

In the case of government budget allocation, for example, each local government has a political and economic distance from the central government, and each local government has the size (weight or flow) of financial resources to run local finances thereof smoothly. In this situation, the needs of each region and its distance from the central government may be taken into consideration to efficiently allocate government financial recourses.

Also, in the case of placing public service facilities such as public healthcare facilities, the distance between cities or the time (distance) required for patients to reach the hospital and the expected volume (flow) of patient flow from each city to the hospital may be used to determine the optimal placement of medical facilities.

QAPs are also common in corporate resource management and business. For example, an automobile manufacturer is assumed to have three parts factories each producing a specific car part and two assembly factories. Sometimes a parts factory should receive semi-finished parts from another parts factory. Finally, all parts should be transported to the appropriate assembly factory.

To minimize overall transportation costs, it is necessary to carefully space (distance) these factories. Also, there may be a weight between two factories. The weight “ω” may be the number of trucks required for the transportation, the weight of the load, etc. In this case, “ω*d” (where d is the distance between the two factories) becomes the final transportation cost. Intuitively, transportation costs may incentivize the close placement of factories with large flows therebetween.

### SUMMARY OF THE INVENTION

The present invention is directed to providing a device and method for solving a problem that, when a deep learning-based parallel computation method is used to find a solution to a quadratic assignment problem (QAP), an existing optimizer does not generate ordered assignment matrices using gradient descent due to random assignment.

According to an aspect of the present invention, there is provided a neural network device for rapidly finding a solution to QAP, the neural network device including a memory and a processor configured to generate logits for locations and facilities on the basis of a QAP instance stored in the memory, generate assignment matrices for the locations and the facilities through deep learning-based parallel processing of the generated logits, and calculate costs on the basis of the generated assignment matrices to find a solution to the QAP.

The processor may update the generated logits using gradient descent and, when the logits reach local optimums, may generate the assignment matrices through the deep learning-based parallel processing.

The processor may derive a parallel-masked softmax function for performing the deep learning-based parallel processing on the basis of a softmax function without constraints on the locations and the facilities and generate the assignment matrices using the parallel-masked softmax function.

The constraints may include a first constraint stating that only one facility is placed in one location and a second constraint stating that one facility is placed in only one location.

The processor may generate the QAP instance by assigning distances between the locations and weights between the facilities stored in a database to the memory.

The processor may generate the multiple assignment matrices within a capacity of a graphics processing unit (GPU) provided in the neural network device.

The processor may calculate costs for the multiple assignment matrices to select an assignment matrix with a minimum cost and find the solution to the QAP from the selected assignment matrix.

When the cost of the selected assignment matrix is lower than an existing cost as a comparison result between the cost of the selected assignment matrix and the existing cost, the processor may update the found solution as an optimal solution.

According to another aspect of the present invention, there is provided a method of rapidly finding a solution to QAP, the method including generating, by a processor, logits for locations and facilities on the basis of a QAP instance stored in a memory, generating, by the processor, assignment matrices for the locations and the facilities through deep learning-based parallel processing of the generated logits, and calculating, by the processor, costs on the basis of the generated assignment matrices and finding a solution to the QAP.

The generating of the assignment matrices may include updating the generated logits using gradient descent and, when the logits reach local optimums, generating the assignment matrices through the deep learning-based parallel processing.

The generating of the assignment matrices may include deriving a parallel-masked softmax function for performing the deep learning-based parallel processing on the basis of a softmax function without constraints on the locations and the facilities and generating the assignment matrices using the parallel-masked softmax function.

The constraints may include a first constraint stating that only one facility is placed in one location and a second constraint stating that one facility is placed in only one location.

The method may further include assigning, by the processor, distances between the locations and weights between the facilities stored in a database to the memory to generate the QAP instance.

The generating of the assignment matrices may include generating the multiple assignment matrices within a capacity of a GPU provided in a neural network device.

The finding of the solution to the QAP may include calculating costs for the multiple assignment matrices to select an assignment matrix with a minimum cost and finding the solution to the QAP from the selected assignment matrix.

The method may further include comparing, by the processor, the cost of the selected assignment matrix with an existing cost, and when the cost of the selected assignment matrix is lower than the existing cost, updating, by the processor, the found solution as an optimal solution.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a diagram showing a network configuration of a neural network device for rapidly finding a solution to a quadratic assignment problem (QAP) according to an exemplary embodiment of the present invention;

FIG. 2 is a diagram showing a system configuration of the neural network device of FIG. 1;

FIG. 3 is a diagram showing a functional configuration of the neural network device of FIG. 1;

FIG. 4 is an example diagram of an assignment matrix based on a two-dimensional (2D) pseudo one-hot;

FIGS. 5A-5B are diagrams illustrating a masked softmax function and a parallel-masked softmax function;

FIG. 6 is an example diagram illustrating pseudo code of an optimal solution finding algorithm according to an exemplary embodiment of the present invention;

FIG. 7 is a table showing results of experimenting on a runtime required for finding a solution;

FIG. 8 is a table showing results of experimenting on a cost;

FIG. 9 is a table showing results of experimenting on efficiency; and

FIG. 10 is a flowchart illustrating a method of rapidly finding a solution to a QAP according to an exemplary embodiment of the present invention.

### DETAILED DESCRIPTION OF EXEMPLARY EMBODIMENTS

Hereinafter, exemplary embodiments of the present invention will be described. In this process, the thicknesses of lines, the sizes of components, and the like shown in the drawings may be exaggerated for the purpose of clarity and convenience of description. Also, terms to be described below are defined in consideration of functions in the present invention, and the terms may vary depending on the intention of a user or operator or precedents. Therefore, these terms are to be defined on the basis of the overall content of the specification.

Exemplary embodiments of the present invention will be described in detail below with reference to the accompanying drawings such that those skill in the technical field to which the present invention pertains readily implement the present invention. However, the present invention may be implemented in a variety of different forms and is not limited to the embodiments described herein. To clearly describe the present invention, parts irrelevant to the description will be omitted from the drawings, and throughout the specification, like reference numerals refer to like elements.

In the specification, when a part is referred to as “including” a component, other components are not excluded but may be included unless particularly described otherwise.

Description of this specification may be implemented using, for example, a method or process, a device, a software program, a data stream, or a signal. Even if a feature is discussed only in a single form of implementation (e.g., discussed only as a method), the discussed feature may be implemented in another form (e.g., a device or program). The device may be implemented as appropriate hardware, software, firmware, etc. The method may be implemented in a device such as a processor which generally refers to a processing device including, for example, a computer, a microprocessor, an integrated circuit, a programmable logic device, etc.

Quadratic assignment problems (QAPs) will be described in detail before exemplary embodiments of the present invention.

A QAP frequently occurs in the case of placing facilities. When P is a set of facilities and L is a set of locations (|P|=|L|), d(i,j) represents the distance between two locations i and j. ω(k,h) represents the weight (or flow) from a facility k to a facility h. In the present embodiment, non-negative matrices are generated for distance and weight using

$$D ∈ {R}_{\geq 0}^{\vert L \vert \times \vert L \vert} and W ∈ {R}_{\geq 0}^{\vert P \vert \times \vert P \vert} ,$$

respectively. Here, D is symmetrical to the inverse direction, but W may not be symmetrical.

A QAP is to find a one-to-one mapping function m: P→L such that a total transportation cost Σ_{a,b∈P}w_{a,b}d_{m(a),m(b)} may be minimized. This may be defined as follows.

$$\begin{matrix}min \\ A\end{matrix} trace ( WADA ) \qquad [ Expression 1 ]$$

$$subject to {\sum }_{x} {a}_{x , y} = 1 , for each y ∈ L \qquad [ Expression 2 ]$$

$${\sum }_{y} {a}_{x , y} = 1 , for each x ∈ P \qquad [ Expression 3 ]$$

According to Expression 1, A is calculated to minimize the sum (trace) of main diagonal elements of a square matrix composed of weights W and A and distances D and A.

According to Expression 2, only one facility is placed in one location, and according to Expression 3, one facility is placed in only one location. A∈0,1^{|P|×|L|} is an assignment (or permutation) matrix of which an element a_{x,y} is defined by a mapping function m as follows.

$${a}_{x , y} \{ \begin{matrix}0 , & if m ( x ) \neq y \\ 1 , & if m ( x ) = y\end{matrix} \qquad [ Expression 4 ]$$

In Expression 4, the element of the assignment matrix A is 1 when a facility is mapped to a location, and is 0 otherwise. Each row and column of the assignment matrix A is one-hot vector of the matrix A and is referred to as a “two-dimensional (2D) one hot” in the present embodiment.

QAPs are the most fundamental and difficult non-deterministic polynomial time (NP)-hard problems. At the problem size level of n=25, QAPs are already considered very difficult to solve accurately. Also, it was proved that there is no polynomial-time approximation algorithm unless P=NP.

Due to such difficulty in QAPs, many heuristic methods have been proposed over the past decades. However, most methods take much time to find the solution. Such a QAP expresses its objective function as a total transportation cost, and an assignment matrix for acquiring a better optimal solution may be found using Expression 1 that minimizes the total transportation cost.

With the recent advancement of graphics processing units (GPUs), GPU-based technologies such as image classification, text/video generation, conversational chatbots, time-series prediction, and the like are emerging in various fields. According to deep learning, in forward propagation and back propagation processes, numerous parallel computations are performed on the basis of a GPU, the computation results are output to a subsequent layer, computations are repeated, prediction values are compared with ground truth values through an objective function to calculate a loss, and the slope of the objective function is calculated for the weight and bias of each layer and backpropagated. While the slope of the objective function is propagated in the input direction during the backpropagation, the slope of each layer is calculated, and the calculation may be sped up through parallel processing of the GPU.

Such a deep learning method may be applied to QAPs, and logits for all “x”s and “y”s may be defined as θ. Then, the slope of the objective function is calculated using gradient descent based on Expression 9, and the parameter θ of the model is updated using the slope.

Gradient descent may be defined as θ←θ−γ∇trace(Wf′(θ, A′) Df′(θ,A′)). The assignment matrix A obtained in this way is used to calculate a cost for the solution through an objective function. The objective function may be calculated as cost←trace (WADA), which is similar to the deep learning process of calculating a loss between a prediction value of a current model and a ground truth value. According to this method, when the loss is smaller than a current optimal loss, the optimal loss and the parameter θ are stored to update an optimal value.

In this case, when a general gradient descent technique is used, θ is randomly assigned. However, according to a QAP, facilities are not mapped to the same location (only one facility is placed in one location, and one facility is placed in only one location) as shown in Expression 2, and thus facilities should not be assigned to random locations. Accordingly, it is necessary to apply a method of preventing overlapping by excluding existing assignments.

Therefore, exemplary embodiments of the present invention are directed to solving a problem that, when a deep learning-based parallel computation method is used to find a solution to a QAP, an existing optimizer does not generate ordered assignment matrices using gradient descent due to random assignment.

To this end, the present embodiment proposes a parallel-masked softmax function that allows the following two constraints to be applied in parallel by complementing a masked softmax function for removing the necessity of the two constraints in the case of trying to generate assignment matrices to solve a QAP on the basis of a GPU using a deep learning method.
Constraint 1: Only one facility is placed in one location.
Constraint 2: One facility is placed in only one location.

Exemplary embodiments of the present invention will be described in detail below with reference to the drawings.

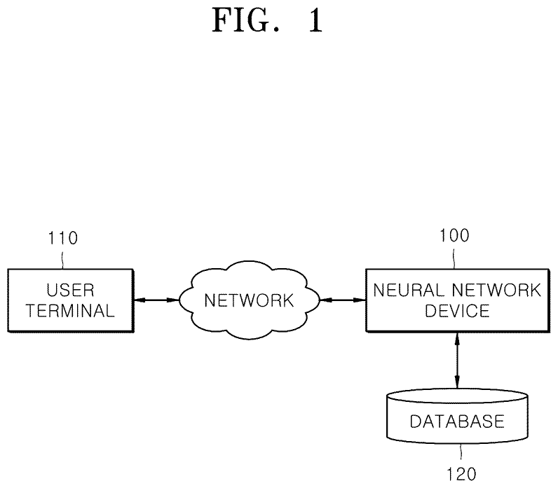

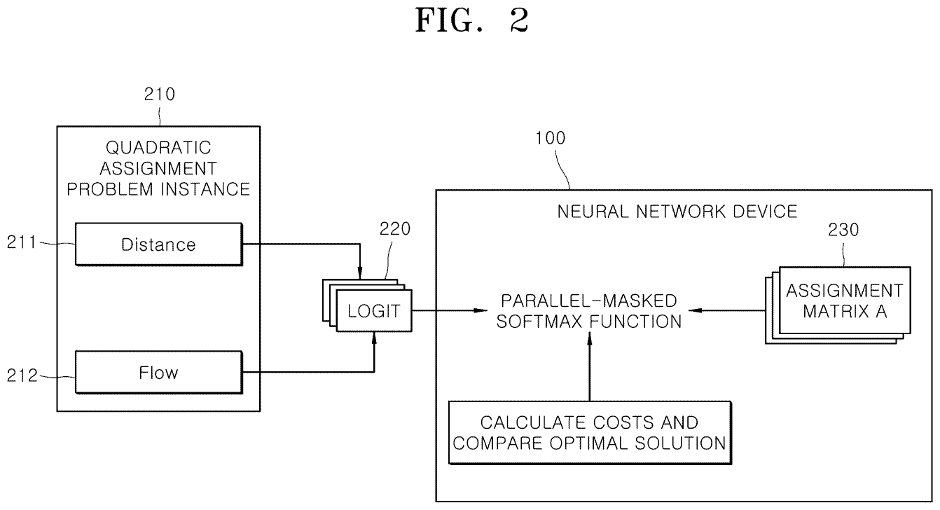

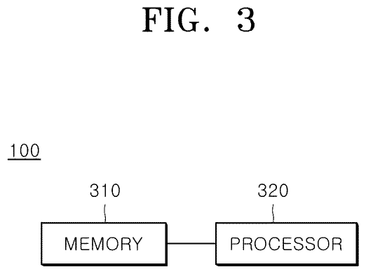

FIG. 1 is a diagram showing a network configuration of a neural network device 100 for rapidly finding a solution to a QAP according to an exemplary embodiment of the present invention, FIG. 2 is a diagram showing a system configuration of the neural network device 100 of FIG. 1, and FIG. 3 is a diagram showing a functional configuration of the neural network device 100 of FIG. 1.

Referring to FIGS. 1 to 3, the network configuration of the neural network device 100 for rapidly finding a solution to a QAP according to an exemplary embodiment of the present invention may include a neural network device 100, a user terminal 110, and a database 120.

The neural network device 100 may generate logits (θ) 220 for all locations and facilities on the basis of a distance 211 and a flow 212 of a QAP instance 210. Here, θ is defined as a matrix including l_{x,y} for all “x”s and “y”s. Also, θ_{x,y} is used to indicate a specific element of θ such as θ_{x,y}=l_{x,y}.

The neural network device 100 updates the generated logits (θ) 220 using gradient descent. When the logits reach local optimums, the neural network device 100 generates multiple assignment matrices 230 within a capacity of a GPU using the parallel-masked softmax function, calculates costs for the assignment matrices 230 using a cost calculation formula, and then finds an optimal solution with the lowest cost.

To this end, the neural network device 100 may include a memory 310 and a processor 320.

The memory 310 may store at least one instruction executed by the processor 320. The memory 310 may be implemented as an internal memory, such as a read-only memory (ROM) (e.g., an electrically erasable and programmable read-only memory (EEPROM)), a random access memory (RAM), or the like included in the processor 320 or may be implemented as a separate memory from the processor 320.

In this case, the memory 310 may be implemented in the form of a memory embedded in the neural network device 100 or a memory detachable from the neural network device 100 depending on the use of stored data.

For example, data for running the neural network device 100 may be stored in the memory 310 embedded in the neural network device 100, and data for an expansion function of the neural network device 100 may be stored in the memory 310 detachable from the neural network device 100.

The memory 310 embedded in the neural network device 100 may be implemented as at least one of a volatile memory (e.g., a dynamic RAM (DRAM), a static RAM (SRAM), a synchronous dynamic RAM (SDRAM), or the like), a non-volatile memory (e.g., a one-time programmable ROM (OTPROM), a programmable ROM (PROM), an erasable and programmable ROM (EPROM), an EEPROM, a mask ROM, a flash ROM, a flash memory (e.g., a NAND flash memory, a NOR flash memory, or the like), a hard disk drive, and a solid state drive (SSD)).

Also, the memory 310 detachable from the neural network device 100 may be implemented in the form of a memory card (e.g., a compact flash (CF) card, a secure digital (SD) card, a micro-SD card, a mini-SD card, an extreme digital (xD) card, a multimedia card (MMC), or the like), an external memory (e.g., a Universal Serial Bus (USB memory)) connectable to a USB port, or the like.

The processor 320 may assign distances between locations and weights between facilities stored in the database 120 to the memory 310 to generate a QAP instance 210 and may store the generated QAP instance 210 in the memory 310.

The processor 320 may generate the logits 220 for the locations and facilities on the basis of the QAP instance 210 stored in the memory 310 and generate the assignment matrices 230 for the locations and facilities through deep learning-based parallel processing of the generated logits 220.

The processor 320 may update the generated logits 220 using gradient descent and, when the logits 220 reach local optimums, may generate the multiple assignment matrices 230 within the capacity of the GPU through the deep learning-based parallel processing. Also, the processor 320 may derive the parallel-masked softmax function for performing the deep learning-based parallel processing on the basis of a softmax function without constraints on the locations and facilities and generate the assignment matrices 230 using the parallel-masked softmax function.

The constraints may include a first constraint stating that only one facility is placed in one location and a second constraint stating that one facility is placed in only one location.

The processor 320 may calculate costs on the basis of the generated assignment matrices 230 to find a solution to the QAP. In other words, the processor 320 may calculate costs for the multiple assignment matrices 230 to select an assignment matrix 230 with the minimum cost and may find a solution to the QAP from the selected assignment matrix 230.

When the cost of the selected assignment matrix 230 is lower than an existing cost as a comparison result between the cost of the selected assignment matrix 230 and the existing cost, the processor 320 may update the found solution as an optimal solution.

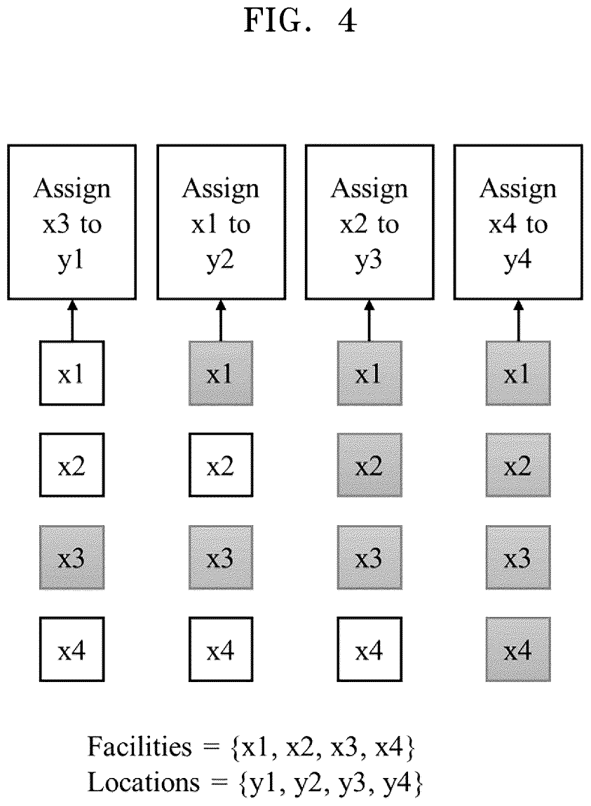

A process of deriving the parallel-masked softmax function applied to the present embodiment and rapidly finding a solution to a QAP will be described below with reference to Expressions 5 to 11 and FIGS. 4 to 11.

According to the present embodiment, a softmax function with temperature annealing is improved to generate assignment matrices for a QAP. Here, a well-known softmax function with temperature annealing is given below as Expression 5.

$$o = [ {o}_{1} , {o}_{2} , … , {o}_{n} ] {o}_{i} = \frac{exp ( \frac{{l}_{i}}{τ} )}{{\sum }_{j = 1}^{n} exp ( \frac{{l}_{j}}{τ} )} \qquad [ Expression 5 ]$$

Accordingly, in the present embodiment, a 2D one-hot matrix is generated using a masked softmax function obtained by improving the softmax function with temperature annealing as shown in Expression 6.

$${a}_{x , y} = \frac{exp ( ( 1 - min ( 1 , {\sum }_{k < y} {a}_{x , k} ) ) {l}_{x , y} / τ )}{{\sum }_{j = 0}^{n} exp ( ( 1 - min ( 1 , {\sum }_{k < y} {a}_{j , k} ) ) {l}_{j , y} / τ )} \qquad [ Expression 6 ]$$

Here, l_{x,y} is a matrix for assigning a facility x to a location y. Therefore, a_{x,y} may be considered the possibility of the case. As described above, since the softmax function with temperature annealing is used as described above, each column becomes close to one hot when τ is very small. In the case of calculating a_{x,y} using Expression 6, the facility x assigned before the column (i.e., location column) y may be excluded. This is performed using (1−min(1, Σ_{k<y}a_{x,k})) and (1−min(1, Σ_{k<y}a_{j,k})), and when τ is small, a row-directional pseudo one hot may be ensured. An example of such 2D pseudo one hot-based assignment matrix is shown in FIG. 4.

Referring to FIG. 4 in detail, first, x3 is randomly mapped to y1. Subsequently, x1, one of x1, x2, x3, and x4 other than x3 which has been previously mapped, is mapped to y2. Subsequently, x2, one of x1, x2, x3, and x4 other than x3 and x1 which have been previously mapped, is mapped to y3, and finally, x4, the remaining one is mapped to y4.

The problem of Expression 7 given below may be solved on TensorFlow using the masked softmax function of Expression 6 without any restriction.

$$\begin{matrix}min \\ θ\end{matrix} trace ( Wf ( θ ) Df ( θ ) ) \qquad [ Expression 7 ]$$

Here, f(θ) is a neural network that generates A from θ∈R^{|P|×|L|} using the masked softmax function of Expression 6. θ is defined as a matrix including l_{x,y} for all “x”s and “y”s. Also, θ_{x,y} is used to indicate a specific element of θ such as θ_{x,y}=l_{x,y}.

However, the masked softmax function of Expression 6 has a problem in the dependency between columns of A. When A_{y} represents a one hot column vector for the location y∈L, Aₖ (k>y) is not calculated without A_{y} that significantly delays calculation. To solve this problem through expansion, it is necessary to improve the masked softmax function.

In the present embodiment, to solve this problem, the parallel-masked softmax function that is expandable is proposed as shown in Expression 8.

$${a}_{x , y} = \frac{exp ( ( 1 - min ( 1 , {\sum }_{k < y} a {}_{x , k}^{′} ) ) {l}_{x , y} / τ )}{{\sum }_{j = 0}^{n} exp ( ( 1 - min ( 1 , {\sum }_{k < y} a {}_{j , k}^{′} ) ) {l}_{j , y} / τ )} \qquad [ Expression 8 ]$$

Here, changed a′_{x,k} and a′_{j,k} are obtained from a previous learning epoch and is considered a constant. When a learning rate γ is sufficiently reduced, a′_{x,k}≈a_{x,k}, a′_{j,k}≈a_{j,k}, and the dependent relationship between a_{x,y} and a_{x,k} (k<y) is removed. The problem (Expression 7) to be solved may be defined through the improved expression as shown in Expression 9 below.

$$\begin{matrix}min \\ θ\end{matrix} trace ( {Wf}^{′} ( θ , {A}^{′} ) {Df}^{′} ( θ , {A}^{′} ) ) \qquad [ Expression 9 ]$$

Here, the parallel-masked softmax function requires a pseudo one hot matrix A′ of a previous epoch, which leads to f′(θ, A′).

When L is an objective function, θ=θ′−γ∇_{θ′}L is given, and Y or ∇_{θ′} L is small, θ≈θ′. In this case, the masked softmax function and the parallel-masked softmax function output similar values, and thus the difference (error) is small. Since γ is a hyperparameter, it is not easy to keep the value small. On the other hand, ∇_{θ′}L may not always be small around a local optimum depending on a feature of L.

However, in the present invention, trace(Wf′(θ, A′) Df′(θ, A′)) is a polynomial for a_{x,y} and is mostly smooth around a local optimum. Therefore, ∇_{θ}L may be regarded as decreasing with the approach of θ to the optimum. In this case, A′ may be used as a surrogate for A. Since this may be considered gradient descent in which ∇_{θ′}L decreases with the approach of A′ to the optimum, A′ may be used as the surrogate.

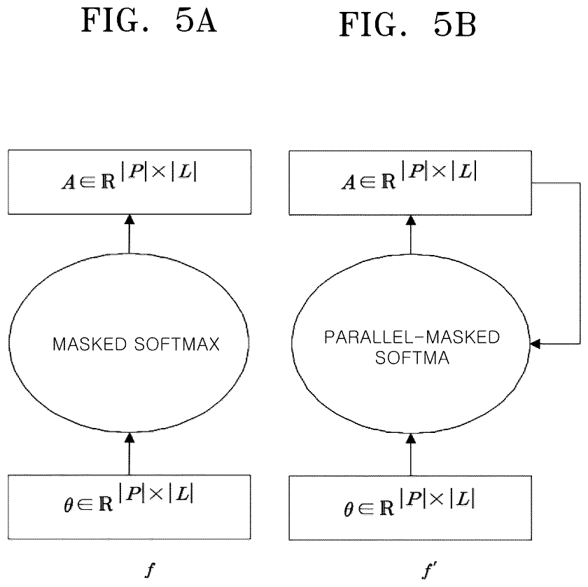

Referring to FIGS. 5A-5B, the masked softmax function and the parallel-masked softmax function will be described below. A neural network f of the present embodiment uses the masked softmax function to find a candidate group (pseudo one hot matrices) A corresponding to the product of 2D matrices for facilities and locations among real numbers. Also, a neural network f′ uses the parallel-masked softmax function to find a pseudo one hot matrix A. Each gradient may be described as follows.

$${∇}_{{θ}_{x , y}} trace ( Wf ( θ ) Df ( θ ) ) \qquad [ Expression 10 ]$$

$${∇}_{{θ}_{x , y}} trace ( {Wf}^{′} ( θ , {A}^{′} ) {Df}^{′} ( θ , {A}^{′} ) ) \qquad [ Expression 11 ]$$

In the case of calculating a gradient, Expressions 10 and 11 differ only in the methods of calculating f(θ) and f′(θ,A′). Since each column may be separately calculated from f′, according to the parallel-masked softmax function, a_{x,y} may be calculated without parallelization at the O(n²)^{th} trial and calculated with parallelization at the O(n)^{th} trial. On the other hand, according to the masked softmax function, parallelization is unusable due to nested definition, and thus a_{x,y} is always calculated at the O(n²)^{th} trial.

Therefore, the parallel-masked softmax function may perform the calculation O(n) times faster than the masked softmax function in accordance with a GPU. A GPU generally has many CUDA cores and may parallelize computations using the CUDA cores. As a result, the parallel-masked softmax function can perform the calculation O(n) times faster than the masked softmax function at maximum with enough parallelization.

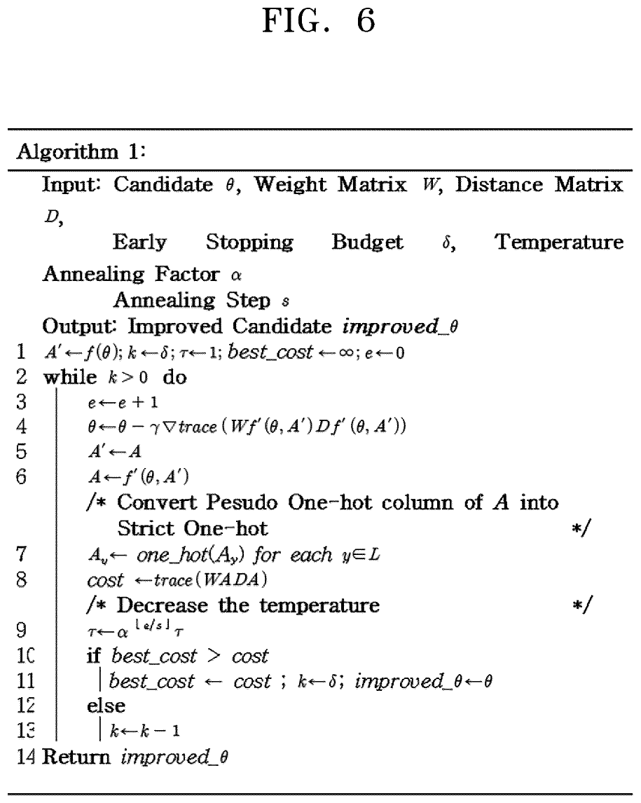

The pseudo code of an optimal solution finding algorithm including the present embodiment will be described below with reference to FIG. 6.

First, to improve a candidate θ, θ is updated at the fourth line of the algorithm using gradient descent. Then, at the seventh line, each column of A converted into a one-hot vector for each column, and a total cost is evaluated at the eighth line. When the total cost is smaller than “best_cost” which is a temporary optimal cost, “improved_θ” which is a temporary optimal candidate is replaced with the updated candidate at the eleventh line. When there is no update until the δ^{th} epoch, the optimization process is finished, and “improved_θ” is returned. Also, a temperature t is annealed at the ninth line. Here, e is a current epoch number, and s is a step parameter.

To perform the present embodiment in parallel on the basis of a deep learning platform, such as TensorFlow, using a GPU, a gradient-based optimizer is necessary, and a generic optimizer, such as adaptive moment estimation (ADAM), may sufficiently help a user to find an optimal solution. Through this procedure, the overall matrix θ may be rapidly optimized due to the efficient characteristic of GPU computations, and thus very high scalability is provided compared to existing “combinatorial optimization” techniques.

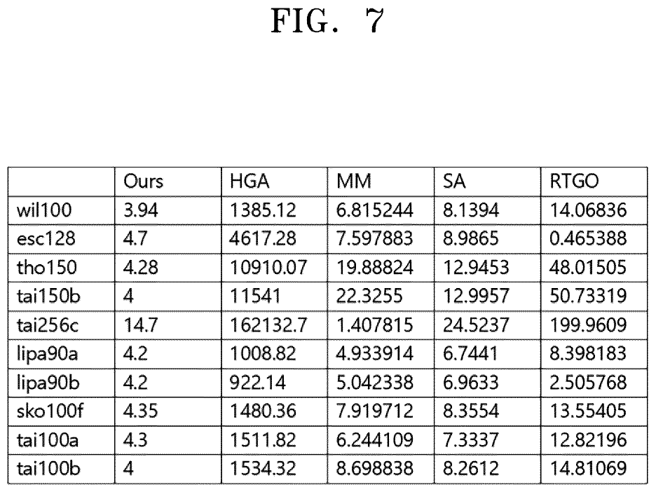

Meanwhile, referring to FIGS. 7 to 9, experimental results of a neural network device and method for rapidly finding a solution to a QAP on the basis of a parallel computation device will be described below. Specifically, results of experimenting on a runtime (a shorter runtime is better) which is a time required for finding a solution, a cost (which is a found final solution, and a lower cost is better), and efficiency (1/\sqrt{cost×runtime}) which is a geometric mean based on the runtime (higher efficiency is better) regarding 10 QAP instances will be described below.

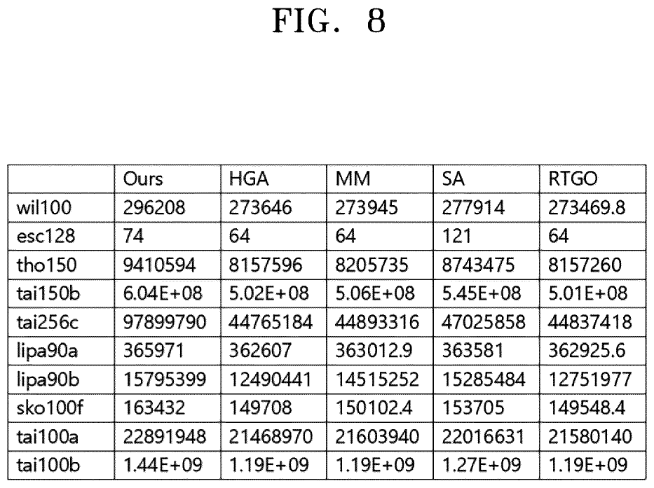

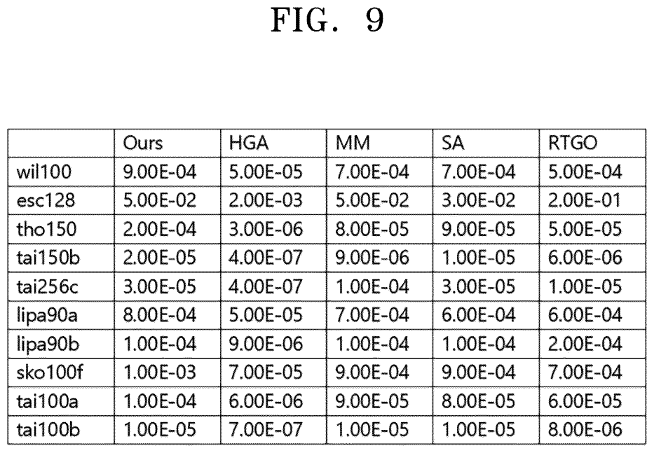

FIG. 7 is a table showing results of experimenting on a runtime required for finding a solution. Ours are experimental results according to the present embodiment and showed shorter runtimes than compared other models. FIG. 8 is a table showing results of experimenting on a cost. Ours are experimental results according to the present embodiment, and most tested models showed similar cost values, and some models showed excellent cost results overall. FIG. 9 is a table showing results of experimenting on efficiency. Ours are experimental results according to the present embodiment and showed better results than other models.

The device described above may be implemented in the form of hardware components, software components, and/or a combination of hardware components and software components. For example, the device and components described in the exemplary embodiments may be implemented using one or more general-purpose computers or special-purpose computers, for example, a processor, a controller, an arithmetic logic unit (ALU), a digital signal processor, a microcomputer, a field programmable array (FPA), a programmable logic unit (PLU), a microprocessor or any other device that may execute and respond to an instruction. A processing device may perform an operating system (OS) and one or more software applications executed on the OS. Further, the processing device may access, store, manipulate, process, and generate data in response to the execution of software. For convenience of understanding, one processing device has been described as being used, but those of ordinary skill in the art may be aware that the processing device may include a plurality of processing elements and/or a plurality of types of processing elements. For example, the processing device may include a plurality of processors or a single processor and a single controller. Further, another processing configuration, such as a parallel processor, is also possible.

Software may include a computer program, code, an instruction, or a combination of one or more thereof and may configure the processing device such that the processing device operates as desired, or may instruct the processing device independently or collectively. Software and/or data may be stored in a storage medium, such as a memory or the like, to be interpreted by the processing device or to provide an instruction or data to the processing device.

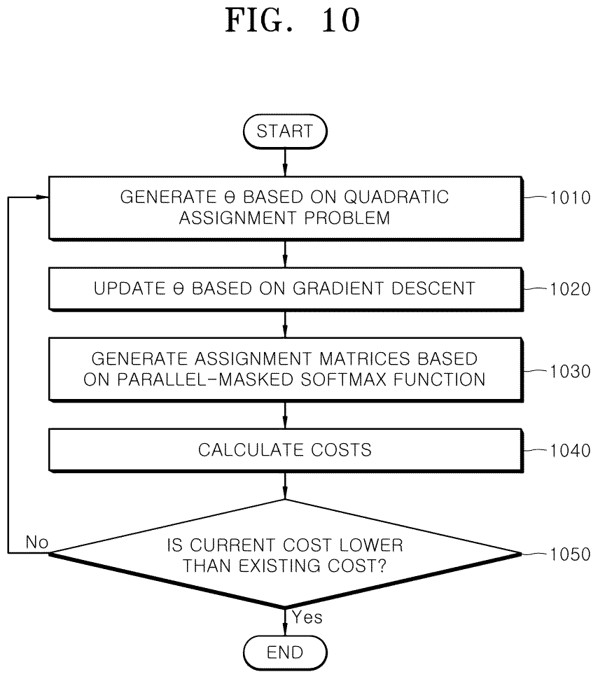

FIG. 10 is a flowchart illustrating a method of rapidly finding a solution to a QAP according to an exemplary embodiment of the present invention.

The method of rapidly finding a solution to a QAP described below is merely an exemplary embodiment of the present invention. Since various operations may be added as necessary or operations described below may be performed in a changed order, the present invention is not limited to each operation described below and the order of operations.

Referring to FIGS. 3 and 10, in operation 1010, the processor 320 may generate logits θ for locations and facilities on the basis of a QAP instance.

Subsequently, in operation 1020, the processor 320 may update the logits θ on the basis of gradient descent.

Subsequently, in operation 1030, the processor 320 may generate assignment matrices on the basis of the parallel-masked softmax function.

Subsequently, in operation 1040, the processor 320 may calculate a cost costₙ on the basis of the assignment matrices to find a solution to the QAP.

When the current cost costₙ is lower than an existing cost costₙ₋₁ (Yes in operation 1050), the processor 320 may update a solution corresponding to the current cost costₙ as an optimal solution and finish the present embodiment.

On the other hand, when the current cost costₙ is not lower than the existing cost costₙ₋₁ (No in operation 1050), the processor 320 may return to operation 1010 and repeat operations 1010 to 1050 at least once.

According to the present invention, it is possible to solve a problem that, when a deep learning-based parallel computation method is used to find a solution to a QAP, an existing optimizer does not generate ordered assignment matrices using gradient descent due to random assignment.

According to the present invention, it is possible to correct temperature annealing-based softmax function on the basis of a GPU and simultaneously generate several 2D assignment matrices through parallelization for a time of O(n).

Although the present invention has been described above with reference to embodiments illustrated in the drawings, the embodiments are merely illustrative, and those of ordinary skill in the art should understand that various modifications and other equivalent embodiments can be made from the embodiments. Therefore, the technical scope of the present invention should be determined from the following claims.

What is claimed is:

1. A neural network device for rapidly finding a solution to a quadratic assignment problem (QAP), the neural network device comprising:
a memory; and
a processor configured to generate logits for locations and facilities on the basis of a QAP instance stored in the memory, generate assignment matrices for the locations and the facilities through deep learning-based parallel processing of the generated logits, and calculate costs on the basis of the generated assignment matrices to find a solution to the QAP.

2. The neural network device of claim 1, wherein the processor updates the generated logits using gradient descent and, when the logits reach local optimums, generates the assignment matrices through the deep learning-based parallel processing.

3. The neural network device of claim 1, wherein the processor derives a parallel-masked softmax function for performing the deep learning-based parallel processing on the basis of a softmax function without constraints on the locations and the facilities and generates the assignment matrices using the parallel-masked softmax function.

4. The neural network device of claim 3, wherein the constraints include a first constraint stating that only one facility is placed in one location and a second constraint stating that one facility is placed in only one location.

5. The neural network device of claim 1, wherein the processor generates the QAP instance by assigning distances between the locations and weights between the facilities stored in a database to the memory.

6. The neural network device of claim 1, wherein the processor generates the multiple assignment matrices within a capacity of a graphics processing unit (GPU) provided in the neural network device.

7. The neural network device of claim 6, wherein the processor calculates costs for the multiple assignment matrices to select an assignment matrix with a minimum cost and finds the solution to the QAP from the selected assignment matrix.

8. The neural network device of claim 7, wherein, when the cost of the selected assignment matrix is lower than an existing cost as a comparison result between the cost of the selected assignment matrix and the existing cost, the processor updates the found solution as an optimal solution.

9. A method of rapidly finding a solution to quadratic assignment problem (QAP), the method comprising:
generating, by a processor, logits for locations and facilities on the basis of a QAP instance stored in a memory;
generating, by the processor, assignment matrices for the locations and the facilities through deep learning-based parallel processing of the generated logits; and
calculating, by the processor, costs on the basis of the generated assignment matrices and finding a solution to the QAP.

10. The method of claim 9, wherein the generating of the assignment matrices comprises updating the generated logits using gradient descent and, when the logits reach local optimums, generating the assignment matrices through the deep learning-based parallel processing.

11. The method of claim 9, wherein the generating of the assignment matrices comprises:
deriving a parallel-masked softmax function for performing the deep learning-based parallel processing on the basis of a softmax function without constraints on the locations and the facilities; and
generating the assignment matrices using the parallel-masked softmax function.

12. The method of claim 11, wherein the constraints include a first constraint stating that only one facility is placed in one location and a second constraint stating that one facility is placed in only one location.

13. The method of claim 9, further comprising assigning, by the processor, distances between the locations and weights between the facilities stored in a database to the memory to generate the QAP instance.

14. The method of claim 9, wherein the generating of the assignment matrices comprises generating the multiple assignment matrices within a capacity of a graphics processing unit (GPU) provided in a neural network device.

15. The method of claim 14, wherein the finding of the solution to the QAP comprises:
calculating costs for the multiple assignment matrices to select an assignment matrix with a minimum cost; and
finding the solution to the QAP from the selected assignment matrix.

16. The method of claim 15, further comprising:
comparing, by the processor, the cost of the selected assignment matrix with an existing cost; and
when the cost of the selected assignment matrix is lower than the existing cost, updating, by the processor, the found solution as an optimal solution.
